(19) United States
(12) Patent Application Publication
(10) Pub. No.: US 2015/0028531 A1
(43) Pub. Date: Jan. 29, 2015

(54) ELASTOMER BEARING

(71) Applicant: Benteler Automobiltechnik GmbH, Paderborn (DE)

(72) Inventors: Hans-Georg Grundmeier, Paderborn (DE); Dietmar Hoffmann, Paderborn (DE)

(21) Appl. No.: 14/444,397

(22) Filed: Jul. 28, 2014

(30) Foreign Application Priority Data
Jul. 29, 2013 (DE) 10 2013 108 065.0

(51) Int. Cl. F16F 1/38; F16C 17/02

(52) U.S. Cl. CPC F16F 1/38; F16C 17/02; F16F 1/3856
USPC 267/141.2; 156/293; 156/250; 156/281

(57) ABSTRACT

An elastomer bearing, includes a cylindrical inner metal part, a metallic outer sleeve arranged at a radial distance around the inner metal part; and an elastomer part arranged between the inner metal part and the metallic outer sleeve. The elastomer part has an outer sheath provided with a plastic layer. The outer sleeve is constructed as a one-piece extruded part made of lightweight metal, and the outer sleeve has an inner sheath surface provided with a profiling which form fittingly engages in the plastic layer.

### CROSS-REFERENCES TO RELATED APPLICATIONS

This application claims the priority of German Patent Application, Serial No. 10 2013 108 065.0, filed 29 Jul. 2013, pursuant to 35 U.S.C. 119(a)-(d), the disclosure of which is incorporated herein by reference.

### BACKGROUND OF THE INVENTION

The present invention relates to an elastomer bearing, the use of an elastomer bearing as bearing for a motor vehicle component and the production of an elastomer bearing.

The following discussion of related art is provided to assist the reader in understanding the advantages of the invention, and is not to be construed as an admission that this related art is prior art to this invention.

Elastomer bearings are used in the motor vehicle field in a broad range of applications. They serve for supporting vehicle parts such as stabilizers or control arms on subframes or on the vehicle body, where they serve for dampening vibrations or decoupling of sounds in order to provide a comfortable driving experience.

Particularly important is the rotation-proof connection of an elastomer bearing to the vehicle body or a subframe in order to ensure sufficient durability and stability of the connection and with this safety during driving. In most cases an elastomer bearing is connected with a subframe or the vehicle body via a metallic outer sleeve or bearing bracket. In order to be able to ensure a rotation-proof connection between an elastomer part and the outer sleeve, both parts are for example connected to each other by vulcanizing. A method for producing composite systems made of metal and polymer form parts is for example disclosed in WO2003/097333 A1. Here the metal parts, for example the outer bracket of a stabilizer bearing, are first provided with a bonding agent or primer, are then pressed with a polymer form part and the two parts then connected to each other by inductive heating.

A similar method is disclosed in DE 199 19 573 A1. Also in this case a metal part, which can be a bearing shell or an outer connection sleeve, is pretreated with an adhesive system. Subsequent thereto an elastomer form part is pressed under moderate pre-tension against the metal part and then the elastomer part, which up to this point is not yet completely vulcanized, is connected by full vulcanization with the metal part.

A disadvantage of these methods is that for the vulcanization an additional labor intensive step with additional tools, heating elements and the like is required, which also increases the costs due to the required energy.

It is also known from the state of the art to press an elastomer part into a metallic outer sleeve and to produce the rotation-proof arrangement by a press fit. The stability of such a press fit however is limited especially when the outer sleeve is provided with a corrosion protective layer which lowers the friction force between the elastomer part and the outer sleeve. There is therefore the risk that the elastomer part slides out of its position in case of high stress in the outer sleeve.

It would therefore be desirable and advantageous to provide an improved elastomer bearing which has a rotation-proof arrangement of its components and in addition can be easily manufactured and mounted.

### SUMMARY OF THE INVENTION

According to one aspect of the present invention, an elastomer bearing includes a cylindrical inner metal part, a metallic outer sleeve arranged at a radial distance around the inner metal part; and an elastomer part arranged between the inner metal part and the metallic outer sleeve, the elastomer part having an outer sheath provided with a plastic layer, the outer sleeve being constructed as a one-piece extruded part made of lightweight metal, the outer sleeve having an inner sheath surface provided with a profiling which form fittingly engages in the plastic layer.

An elastomer bearing according to the invention has a cylindrical inner metal part a metallic outer sleeve, which is arranged at a radial distance about the inner metal part and an elastomer part, which is arranged between the inner metal part and the outer sleeve. The elastomer part has at its outer sheath surface a plastic layer. The outer sleeve is a one-piece extruded part made of light metal and has at its inner sheath surface a profiling which form fittingly engages in the plastic layer of the elastomer part.

Such elastomer bearings can be used especially in the vehicle body region of motor vehicles at many locations. For example they can serve as bearings for stabilizers wherein then a section of the stabilizer forms the cylindrical inner metal part of the bearing. These elastomer bearings are also suited for connection of camber and toes control arms, of longitudinal control arms of composite steering axles, of swing connectors or axle carriers.

The outer sleeve is made of a lightweight metal for example aluminum and is produced as cut-to-size extruded profiles. The profiling on the inner sheath surface of the outer sleeve results in a form fit with the plastic layer of the elastomer part. This form fit results in a rotation-proof fixation so that the outer sleeve and the elastomer part always have the same position relative to each other.

For the producing of the inner profiling extrusion is particularly advantageous. The inner profiling can then be formed directly during the production process of the outer sleeve and does not have to be introduced retroactively into the outer sleeve by a material removing method.

The use of aluminum or another extrudable lightweight metal is advantages for many reasons. Conventional is the use of steel shells or steel sleeves, which due to their corrosion proneness have to be provided with an additional protective layer. Such steel sleeves are made of high-strength steel in order to account for the constant stress during use in the vehicle, and to achieve a smallest possible weight at sufficient strength.

On the other hand aluminum on the other hand offers a significant weight advantage also compared high strength steel, which is advantageous, in particular considering the current desire for lightweight construction.

When using aluminum it is also not necessary to provide the other sleeve with an addition corrosion protective layer because aluminum is naturally very corrosion resistant.

The production of a profiling according to the invention for forming a form fit between the outer sleeve and the elastomer part is hard to accomplish especially in the case of high-strength steel materials. In this case a material removing treatment of the steel elements would be necessary, which in the case of high-strength materials can be performed only with high effort. This additional work step in the case of steel materials can be conveniently integrated in the production process of the metallic outer sleeve.

In a particular embodiment of the invention, the profiling is configured as a number of webs, which extend on the inner sheath surface at least in sections parallel to the longitudinal axis of the outer sleeve.

The longitudinal axis of the outer sleeve means the axis which lies parallel to the inner sheath surfaces of the outer sleeve and along which the cylindrical inner metal part extends.

The webs thus extend from one axial end of the inner sheath surface to the other axial end, wherein they can be configured continuous and may also have interruptions.

It is also possible that the webs extend in a helical winding from one axial end to the other axial end of the outer sleeve. In this case, the webs form a type of inner threading, wherein the outer sleeve as a consequence has to be pressed onto the elastomer part in a rotating movement.

In a particularly preferred embodiment the webs, which extend parallel to the longitudinal axis, have an essentially triangular cross section. In this configuration the webs can burrow into the plastic layer of the elastomer part with the triangular tip which points in the direction of the elastomer part when pressing the outer sleeve onto the elastomer part. This also means a cutting/milling. This creates a form fit between the outer sleeve and the plastic layer of the elastomer part with minimal effort.

The corner of the triangle, which protrudes into the inner space of the outer sleeve, in this case does not necessarily have to be formed as a tip. It can also be a rounded tip which also enables a form fit with the plastic layer and can technically be formed easier during the extrusion method.

For the triangular shape of the webs different configurations are conceivable. The webs can have a cross section in the form of an equilateral triangle. When on the other hand a deeper engagement of the profiling into the plastic layer is required, a configuration as isosceles triangle is also possible, wherein in this case the height of the triangle is greater than the base of the, triangle. The height or the width of the triangle cross sections depends on the demands placed on the respective inner profiling. It may thus be necessary to provide a greater number of webs that engage deeper into the plastic layer. On the other hand it is also possible that only a small number of webs is required, which are distributed spaced apart along the circumference of the inner sheath surface and which have a smaller height of the webs.

In particular the expected torsion stress plays a role in the exact configuration of the outer sleeve according to the invention. At high torsion forces a greater number of webs is necessary in order to ensure the rotation resistance of the elastomer bearing. When only the elastomer part is to be non-detachably held on the outer sleeve a smaller number of webs can be selected.

In case of an uneven stress in both rotational directions it is useful to configure the cross section of the inner profiling as non-symmetric triangle. This means that the two sides of the triangle, which points into the inner space oft the outer sleeve, enclose different angles with the base surface of the triangle. In an elastomer bearing, which for example is exclusively exposed to stress in one rotational direction, the side of the triangle, which absorbs this rotational stress protrudes steeper into the inner space than the other triangle side. The base angle, which is enclosed by the stressed side, is then greater than the opposing base angle. The averted side surface of the triangle on the other hand extends shallower so that the elastomer part in case of a rotational stress can glide over this side of the triangle.

Also a mandrel-shaped configuration of the triangular cross section of the webs of the profiling is possible. In this case the side surfaces of the triangle which protrude into the inner region of the outer sleeve are configured concave, which results in a sharp tip compared to the base surface, which facilitates the forming of the form fit between the profiling and the plastic layer.

Preferably the webs are evenly distributed over the circumference of the inner sheath surface. As a result in particular an even load on the elastomer part is created so that in case of a strong torsional load the forces are evenly distributed across the elastomer part.

As described above the height of the profiling also depends on the magnitude of the occurring forces. Preferably the height of the profiling is 0.1% to 3% of the diameter of the elastomer bearing. In particular the overall height of the elastomer bearing plays an important role in this case. When the elastomer bearing has a great diameter, the profilings also have to be adjusted correspondingly in order to be able to compensate the occurring forces.

Of course the profiling should however not be configured so large so as to perforate the plastic layer of the elastomer part and burrows into the elastomer part itself. This would lead to crack formation in the elastomer part, which in turn would adversely affect the durability of the entire elastomer bearing.

All embodiments of the outer sleeve mentioned above can be advantageously generated very easily by means of different templates on the extrusion device. Almost any desired variations are possible. In order to change from one variant to the next it is not necessary to change the production tools in a laborious manner. Only exchange of the template of the extrusion system is required. As a result the production times of outer sleeves according to the invention are significantly reduced.

In a further embodiment of the elastomer bearing, it is provided that the elastomer part forms a press fit with the outer sleeve by integrating the plastic layer.

Hereby the elastomer part is pre-tensioned during pressing into the outer sleeve. As a result the plastic layer, which surrounds the elastomer part, is pressed against the outer sleeve. Overall a press fit is generated which in addition to the profiling of the outer sleeves effectively counteracts an undesired rotation of the components. A dual protection against the rotating of the components is generated, wherein the press fit and the form fit of profiling and plastic layer cooperate. This distinguishes the invention from conventional elastomer bearings with a bearing bracket or a steel bearing eye as outer sleeve, which due to the high strength of the material cannot be provided with a corresponding profiling, and where the rotation-proof connection is only generated by a press fit. Because steel is sensitive against corrosion and correspondingly has to be provided with a coating which lowers the friction between the outer sleeve and the elastomer part, such conventional elastomer bearings often involve the risk that the outer sleeves slip from the elastomer part or the elastomer parts rotate in the outer sleeves.

In a further preferred embodiment of the invention, the elastomer part is configured multi-part. The elastomer part as a whole usually has a cylindrical basic shape with a bore for the inner metal part and can be pushed onto the inner metal part. In case of components with complex shapes such as stabilizers it is often not possible to simply push the elastomer part into the provided bearing region. In this case it is advantageous to form the elastomer part from two or more individual elements.

In a preferred embodiment of the elastomer bearing the outer sleeve is configured as multi-chamber extruded profile.

Such an extruded profile has a chamber, which serves as outer sleeve for the elastomer part. This chamber is usually circular and has the profiling according to the invention at its inner sheath surface. The additional chambers serve as connection elements by means of which the outer sleeve can be arranged on the vehicle body or a subframe or on a control arm. The shape of these additional chambers can be adjusted to the predetermined attachment sites in any desired manner.

For example a circular opening can also be generated so that a connection via a bolt or a threaded connection is possible. By a subsequent material removing processing a threading can be introduced here.

Also any other desired connection element can be molded by which then a form fitting connection with the vehicle body of the subframe can be generated.

The outer sleeve further has preferably attachment elements and/or openings, which are generated by material removing processing. Also these embodiments of the invention serve for enabling attachment of the outer sleeve on the vehicle body or subframe and the like. Thus it is possible that oblong holes, grooves or threadings are introduced into the aluminum extruded profiles by which then in turn bolts or screws can be guided in order to enable the attachment of the outer sleeve.

Especially in combination with the configuration of the outer sleeve described above as multi chamber extruded profiles, many design possibilities exist in order to produce attachment elements and/or attachment openings that are adjusted to the mounting space and the constructive demands.

A further particular embodiment of the invention provides that the inner metal part is a hollow cylinder. In this embodiment an attachment site for the control arm, for example on the wheel carrier, is created when using the elastomer bearing on a vehicle control arm.

In a further embodiment of the invention, it is provided that the elastomer part is connected with the inner metal part via an adhesive connection or is vulcanized onto the inner metal part.

Also on the connection site between the inner metal part and the elastomer part it is necessary to obtain a sufficient rotation resistance and stability of the elastomer par. This can be achieved by a material bonding connection such as an adhesive connection or vulcanizing. The adhesive connection as wells as the vulcanizing can be realized very easily during assembly because the inner metal part is easily accessible and can easily be provided with glue or adhesives.

After arranging the elastomer part on the thus pretreated inner metal part, the metallic outer sleeve can also already be pushed on so that the adhesive connection or vulcanizing can be produced under the pre-tension generated by the outer sleeve.

A further embodiment of the invention provides that the plastic layer is vulcanized onto the elastomer part.

In order to ensure that the rotation resistance, which is generated by the form fit between the profiling of the outer sleeve and the plastic layer, is stable a durable connection between the plastic player and the elastomer part also has to be established. Because here a load bearable mechanical connection is difficult to achieve, a vulcanizing is most appropriate to generate a rotation-proof connection between the elastomer part and the plastic layer.

In a further embodiment of the invention, the elastomer part of the elastomer bearing has a circumferential shoulder on the axial borders of its outer sheath surface.

Beside the rotation resistance of the elastomer part in the outer sleeve, the axial non-displacability of the elastomer part in the outer sleeve is also an important criteria for the proper functioning of the elastomer bearing. The elastomer part therefore has a shoulder its front side ends. This means that the diameter of the elastomer part at its axial borders is slightly greater than in the remaining regions. As a result the elastomer part overlaps the outer sleeve with the shoulders and thus ensures that the outer sleeve cannot slide off the elastomer part in case of an axial load on the elastomer bearing. This also occurs in cooperation with the press fit between the elastomer part and the outer sleeve, which additionally supports the axial direction.

In a preferred embodiment, the outer sleeve has on the axial borders if its inner sheath surface a circumferential chamfer, which is in engagement with the shoulder of the elastomer part.

This means that the outer sleeve at its axial ends has a slightly greater inner diameter than in the center regions. This border region is configured complementary to the shoulder of the elastomer part so that the chamfer of the outer sleeve and the shoulder of the elastomer part engage in each other. As a result the axial securement is further improved so that the elastomer part is securely held in the outer sleeve.

Preferably the plastic layer on the outer sheath surface of the elastomer part is made of polyamide.

The elastomer bearing according to the invention may be used as a bearing for a motor vehicle part. In particular this involves applications in parts in the vehicle chassis area, for example a stabilizer bearing or as attachment bearing for a control arm. It can also be used on a subframe or on a twist beam axle, as connection to the vehicle body or the like.

The configuration of the outer sleeve as extruded profiles allows using the elastomer bearing according to the invention in a broad range of applications. The configuration of the extruded profiles can be adjusted to the application, wherein multiple geometrical configurations are available.

According to another aspect of the invention, a method for producing an elastomer bearing, includes providing a cylindrical inner metal part, an elastomer part having a plastic layer on its outer sheath surface, and an outer sleeve, which is produced as one-piece extruded part from lightweight metal; pre-treating a surface of the cylindrical inner metal part; bringing the elastomer part into contact with the inner metal part; joining the elastomer part with the inner metal part with an adhesive or by vulcanizing; and pressing the outer sleeve onto the elastomer part during or after the joining, so that a profiling of an inner sheath surface of the outer sleeve comes into form fitting engagement with the plastic layer.

In this method the cylindrical inner metal part, which can be a solid or hollow cylinder or a bearing section of a stabilizer, is thus first provided with an adhesive or a bonding agent of the vulcanizing.

Subsequent thereto an elastomer part is brought into contact with the inner metal part in the region, which is provided with adhesive or bonding agent. The elastomer part can be made of a single piece, which has a cylindrical bore and is then pushed onto the cylindrical inner metal part.

However, it is also possible to use a multi-part elastomer part for example two half shells which then together form the elastomer part for the elastomer bearing. This variant is particularly advantageous when, as in the case of a stabilizer, the pushing on of a one-piece elastomer part is difficult or even impossible due to the geometrical configuration of the cylindrical inner metal part.

The outer sleeve is then pressed onto the elastomer part. This can occur before the adhesive connection or the vulcanizing is performed, for example in order to use the pre-tension generated by the outer sleeve in the elastomer part to support the generation of the materially bonding connection during the gluing or vulcanizing. On the other hand the outer sleeve can also be pressed onto the elastomer part, which is already securely connected with the inner metal part.

The outer sleeve has at its inner sheath surface a profiling, which during the pressing on comes into form fitting engagement with the plastic payer. As a result of this form fit an undesired rotation of the outer sleeve relative to the elastomer part is prevented.

For generating the form fitting engagement, the plastic layer is treated with material removing processing, cutting or is plastically deformed by the profiling during pressing on.

The pressing of the outer sleeve onto the elastomer part generates a pre-tension in the elastomer part, which in turn presses the elastomer part outwardly against the profiling. Depending on the strength of the pre-tension and the geometrical configuration of the profiling, the form fit is generated in different ways. Thus it is for example possible that the inner profiling removes a portion of the plastic layer, and so to speak mills a groove, in which the profiling then engages. The removed plastic material pushes the profiling during the pressing on process along in front of it. After completing the pressing on the removed material falls off.

When the profiling as described above is configured web-shaped and with a sharp tip, the engagement can also be generated by a cut of the inner profiling into the plastic layer.

It is also possible that the plastic layer is plastically deformed by the profiling without resulting in cracks, a tension or the like in the plastic. Then, the plastic layer is pressed against the profiling due to the pre-tension and is thereby plastically deformed. The resulting grooves can then engage in the profiling.

A further embodiment of the method provides that the surface of the cylindrical inner metal part is cleaned during the pretreatment and/or are provided with a primer.

A cleaning of the region in which the elastomer part is to be connected with the cylindrical inner metal part is advantageous because it significantly improves the subsequently generated material bonding connection. The cleaning can occur by means of chemicals, by heat treatment or by mechanical treatment. As a result of the cleaning the surface of the inner metal part is cleared of dirt and contaminations so that the subsequently generated material bonding is of higher quality.

Also the application of a primer serves to improve the adhesion between the inner metal part and the glue or the vulcanizing process.

It is further provided to heat the elastomer part to a temperature of 50° C. to 100° C., preferably of 60° C. to 80° C. prior to pressing on the outer sleeve.

As a result of this temperature treatment the elastomer part and the plastic layer become softer and more flexible thereby facilitating the generation of the form fitting engagement between the profiling and the outer sleeve and the plastic layer. In this case lower pressing forces are required so that the elastomer part is exposed to less stress during the pressing in process. This minimizes the risk of crack formation and with this less waste is produced or the durability of the elastomer bearings improved.

In a further embodiment of the method, the plastic layer is connected with the elastomer part by vulcanizing. This allows generating a stable and rotation-proof connection between the plastic and the elastomer part in a simple manner.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an elastomer bearing according to the invention in an embodiment as stabilizer bearing;

FIG. 2 shows an elastomer bearing according to the invention;

FIG. 3 shows an outer sleeve in a perspective view;

FIG. 4a shows an outer sleeve in a cross section;

FIG. 4b shows a section of FIG. 4a;

FIG. 4c shows the outer sleeve with inserted elastomer part; and

FIGS. 5a to e show individual variants of the cross sectional shape of the profiling.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

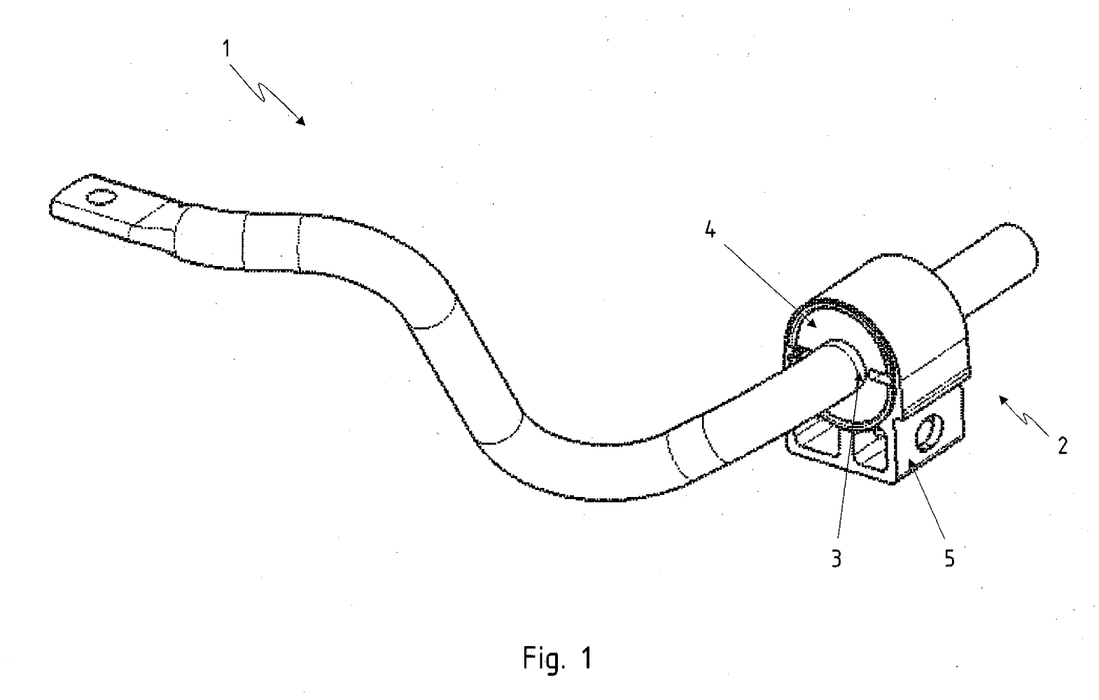

An exemplary embodiment for an elastomer bearing according to the invention is the use of such a bearing for connecting a stabilizer to the vehicle body or a subframe. FIG. 1 shows an end side section of a stabilizer 1. Not shown are the center section and the other end of the stabilizer. The latter is configured equivalent to the here shown end. The stabilizer 1 as a stabilizer bearing 2 which is arranged on a bearing region 3 of the stabilizer 1.

This stabilizer. 2 has an elastomer part 4 which surrounds the Bering region 3 of the stabilizer 1. On its outer sheath surface the elastomer part 4 has a plastic layer which is here not further shown. The elastomer part 4 is surrounded by an outer sleeve 5. This outer sleeve 5 past on its inner sheath surface a profiling which is here also not for the show and which form fittingly engages in the plastic layer of the elastomer part 4.

For producing a stabilizer bearing 2 that bearing region 3 of the stabilizer 1 is first cleaned of contaminations for example lubricant residues zunder or oxidations. Thereafter a primer and a bonding agent are applied whereupon the elastomer part 4 is pushed onto the stabilizer 1 and contacts to stabilize a 1 in the bearing region 3. The elastomer part 4 is at this time point already provided is a plastic layer on its outer sheath surface.

The elastomer part 4 is then pressed against the bearing region 3 and vulcanized onto the bearing region 3 under pre-tension and temperature influence.

The outer sleeve 5 is then pressed onto the elastomer part 4. Hereby the elastomer part 4 was first heated to a temperature of 50° C. to 100° C., preferably 60° C. to 80° C. During pressing the outer sleeve 5 onto the elastomer part 4 the inner sheath surface of the outer sleeve 5 comes into form fitting engagement with the plastic layer of the elastomer part 4. During the pressing on of the outer sleeve 5 the elastomer part 4 is pre-tensioned. As a result of this pre-tension the elastomer part 4 is pressed against the outer sleeve 5. As a result of this pressing force the inner profiling of the outer sleeve 5 is pressed into the plastic layer of the elastomer part 4. The plastic layer is thereby plastically deformed so that together with the inner profiling it forms a form fit. As a result of the heating the elastomer part 4 becomes softer and with this slightly more malleable thus facilitating the generation of the form fit.

As a result of the pre-tension of the elastomer part 4 a press fit is formed between the elastomer part 4 and the outer sleeve 5 by integrating the plastic layer.

As a result of the combination of press fit and form fit, a rotation-proof connection between the elastomer part 4 and the outer sleeve 5 is generated which prevents that during springing out of a vehicle wheel and the resulting rotation of the stabilizer the elastomer part 4 can slide in the outer sleeve 5, whereby the stabilizer bearing 2 is stably connected to the vehicle body.

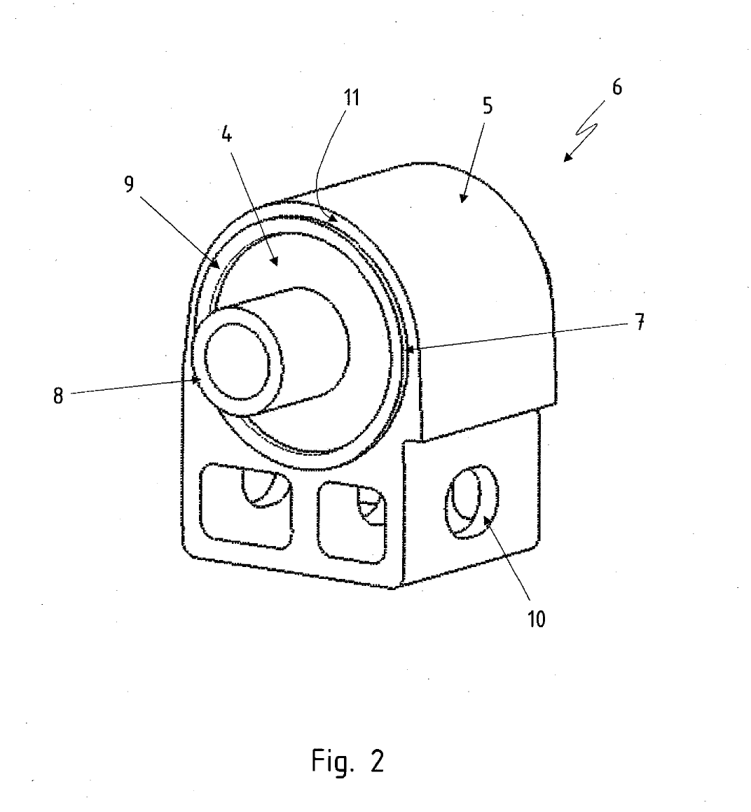

An elastomer bearing 6 according to the invention is shown in FIG. 2. This embodiment is for example suited as control arm connection.

In this case, the elastomer bearing 6 has a cylindrical inner metal part 8, which is surrounded by an elastomer part 4. The elastomer part 4 has a plastic layer 7 at its outer sheath surface. The elastomer part 4 in turn is surrounded by an outer sleeve 5. On the axial borders of its outer sheath surface the elastomer part 4 forms a shoulder 9. This shoulder 9 overlaps the end faces 11 of the outer sleeve 5. Together with the press fit this achieves that the elastomer part 4 is also non-displaceably held in the outer sleeve 5. The outer sleeve 5 also has a connection opening 10 by which the elastomer bearing 6 can be connected to another vehicle part by means of a bolt or a threaded connection.

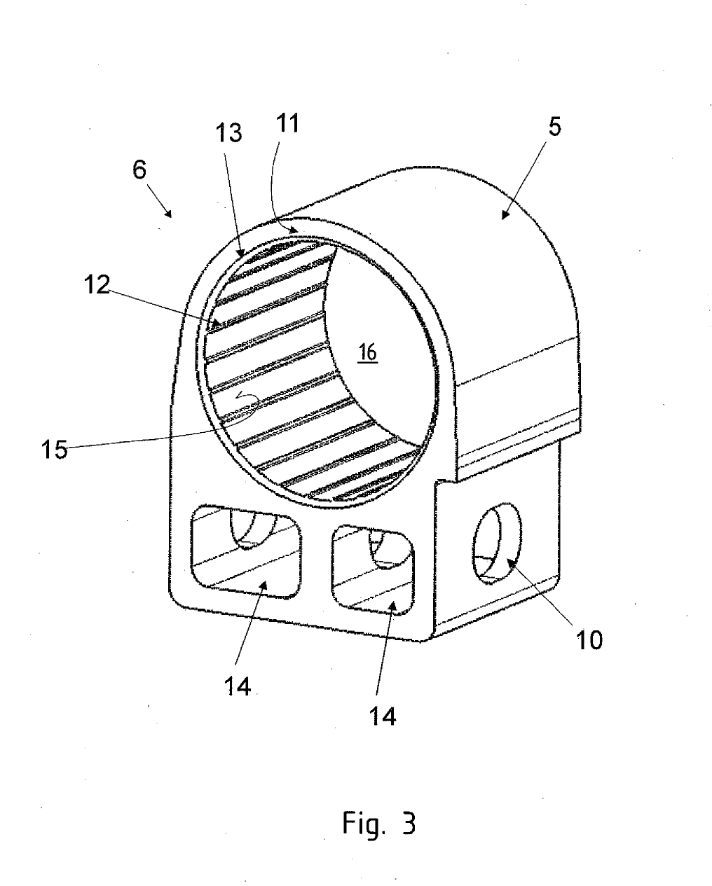

FIG. 3 shows an outer sleeve 5 without inner metal part 8 or elastomer part 4. Here the profiling 12 can be clearly seen, which is configured in the form of webs which extend on the inner sheath surface 15 parallel to the longitudinal axis of the outer sleeve 5.

On the axial borders of the inner sheath surface 15, the outer sleeve 5 has a chamfer 13 which engages with the shoulder 9 of the elastomer part 4 shown in FIG. 2. As a result the elastomer part 4 is secured in the outer sleeve 5 against displacement in axial direction.

In addition the outer sleeve 5 has a connection opening 10 and connection elements 14.

The outer sleeve 5 according to the invention is made of a lightweight metal, preferably aluminum, and is produced as extruded profile. This embodiment represents an extruded profile with three chambers. One chamber forms the receiving opening 16 for the elastomer part 4, whereas the other two chambers form the connection elements 14. During the extrusion, the profiling 12 is already formed on the inner sheath surface 15. A further material removing processing of the outer sleeve after producing the outer sleeve is therefore not strictly required to produce this profiling 12.

Nevertheless further processing steps may follow for example in order to produce the chamfer 13 or a connection opening 10.

Using aluminum or another lightweight metal as working material in addition saves weight. This weight saving can be further improved in that superfluous material is omitted. For example the additional chambers, which are here configured as connection elements 14, can also be configured without the requirement of a connection possibility. This saves material and with this costs and additional weight.

By using aluminum as material it is further not necessary to apply an additional corrosion protection to the outer sleeve 5 as it would be required in the case of conventional sleeves made of steel, because aluminum is already corrosion resistant itself.

By using extrusion as manufacturing method it is also possible to configure the outer sleeve 5 very application oriented and to adjust it to the requirements.

Thus for example the number and position of the web shaped profilings 12 can be very easily varied in this exemplary embodiment depending of the demands on the entire component.

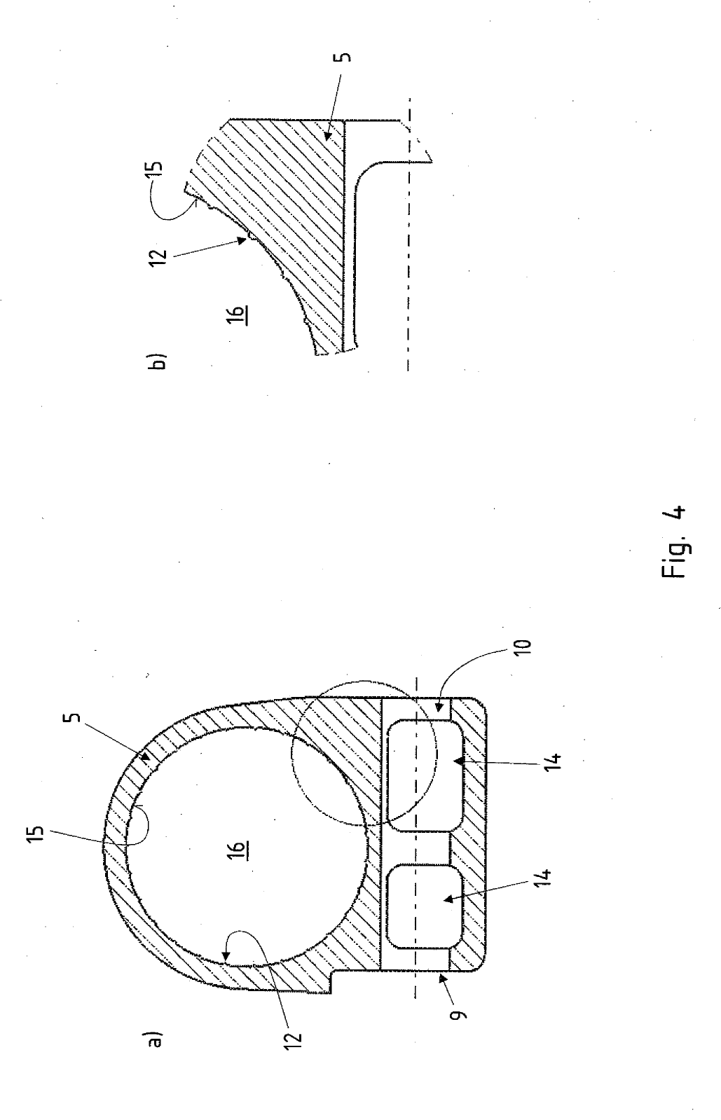

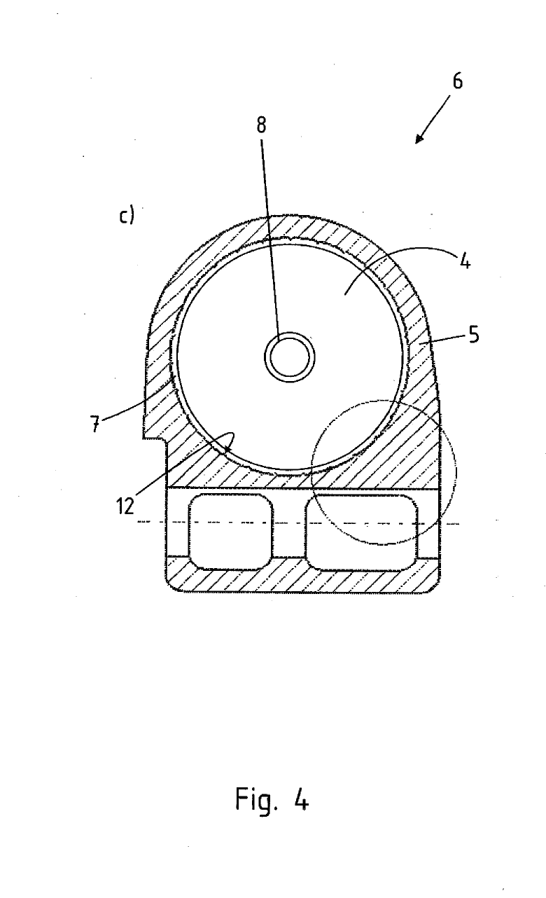

In this exemplary embodiment, the cross section of the profiling 12 is configured substantially triangular as shown in FIG. 4b. FIG. 4b shows an enlargement of a section of FIG. 4a, which in turn shows a cross section of the outer sleeve 5.

The triangular cross section of the profiling 12 is in this case equilateral triangles, wherein the tips of the triangles which point into the receiving opening 16 are not configured pointed but are rounded.

A variation of the cross sectional shape of the profiling is readily possible. Thus it is conceivable to configure asymmetric triangles for example in the form of a saw tooth, or mandrel-like triangles.

FIG. 4c also shows the principle construction of the elastomer bearings (6) according to the invention, and illustrates particularly well that the plastic layer 7 circumferentially embraces the elastomer part 4 and is in form fitting engagement with the profiling 12 which extends radially inward. The inner metal part 8 itself in turn is located in the elastomer part 4.

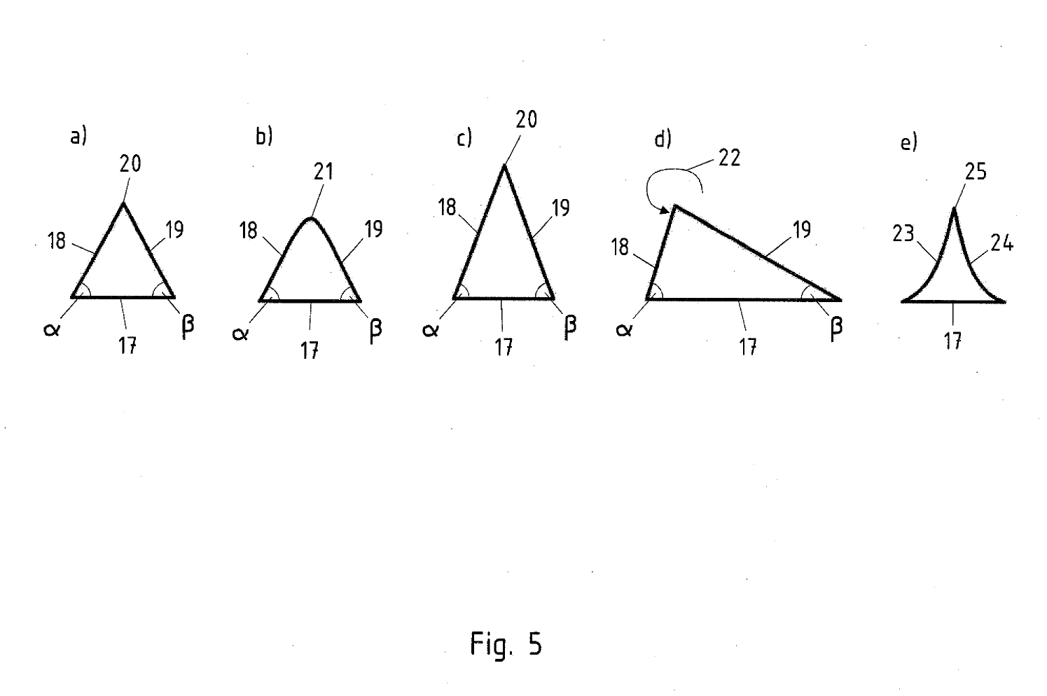

Individual variants of the cross sectional shape of the profiling 12 are shown in FIG. 5. FIG. 5a shows the configuration of a profiling 12 with an equilateral triangle as cross section. The base 17 of the triangle is formed by the inner sheath surface 15 of the outer sleeve 5. The two side surfaces 18, 19 of the triangle enclose the base angles α, β with the base 17. The tip 20 of the triangle protrudes into the receiving opening 16 of the other sleeve 5. FIG. 5b shows a variation of the equilateral triangle, wherein the tip 21 is rounded and not tapered pointed as in the preceding exemplary embodiment.

When the profiling 12 is to engage deeper into the plastic layer 7, an isosceles triangle is formed as possible cross sectional shape as shown in FIG. 5c. Hereby the length of the base 17 remains constant relative to the preceding examples. However, the sides 18, 19 of the triangle are longer. The height of the triangle is thus greater than the length of its base.

A possible embodiment of the asymmetric configuration of the triangle cross section is shown in FIG. 5d. Here a rotational force 22 occurs which pushes against the side 18 of the triangle. In order to account for this one sided load the triangle is configured asymmetric where the angle α, which is enclosed between the side 18 and the base 17, is greater than the angle β, which is enclosed by the side 19 and the base 17. The side 18 correspondingly extends much steeper than the side 19 almost perpendicular to the base 17 so that a such configured profiling represents an effective resistance against the force 22.

A mandrel-like configuration of the triangle is shown in FIG. 5e. Here the triangle has concave sides 23, 24, which allows the tip 25 to be configured sharper than for example in the examples 5a and 5c.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and, practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An elastomer bearing, comprising:
a cylindrical inner metal part,
a metallic outer sleeve arranged at a radial distance around the inner metal part; and
an elastomer part arranged between the inner metal part and the metallic outer sleeve, said elastomer part having an outer sheath provided with a plastic layer, the outer sleeve being constructed as a one-piece extruded part made of lightweight metal, the outer sleeve having an inner sheath surface provided with a profiling which form fittingly engages in the plastic layer.

2. The elastomer bearing of claim 1, wherein the profiling is configured as webs which extend on the inner sheath surface of the outer sleeve at least in sections parallel to a longitudinal axis of he outer sleeve.

3. The elastomer bearing of claim 2, wherein the webs have a substantially triangular cross section.

4. The elastomer bearing of claim 2, wherein the webs are evenly distributed over a circumference of the inner sheath surface.

5. The elastomer bearing of claim 1, wherein a height of the profiling is 0.1% to 3% of a diameter of the elastomer bearing.

6. The elastomer bearing of claim 1, wherein the elastomer bearing forms a press fit with the outer sleeve by integrating the plastic layer.

7. The elastomer bearing of claim 1, wherein the elastomer part is configured multi-part.

8. The elastomer bearing of claim 1, wherein the outer sleeve is configured as multi-chamber profile.

9. The elastomer bearing of claim 1, wherein the outer sleeve has connection elements and/or connection openings, which are produced by a material removing processing.

10. The elastomer bearing of claim 1, wherein the inner metal part is constructed as a hollow cylinder.

11. The elastomer bearing of claim 1, wherein the elastomer part is connected with the inner metal part via an adhesive connection or via vulcanization to the inner metal part.

12. The elastomer bearing of claim 1, wherein the plastic layer is vulcanized onto the elastomer part.

13. The elastomer bearing of claim 1, wherein the elastomer part has a circumferential shoulder on axial borders of its outer sheath surface.

14. The elastomer of claim 13, wherein the outer sleeve has a circumferential chamfer on axial borders of its inner sheath surface, said chamfer being in engagement with the shoulder of the elastomer part.

15. The elastomer bearing of claim 1, wherein the plastic layer is made of polyamide.

16. The elastomer bearing of claim 1, for use as a bearing for a motor vehicle, in particular a stabilizer, a control arm, a subframe or a composite axle.

17. A method for producing an elastomer bearing, comprising:
providing a cylindrical inner metal part, an elastomer part having a plastic layer on its outer sheath surface, and an outer sleeve, which is produced as one-piece extruded part from lightweight metal;
pre-treating a surface of the cylindrical inner metal part;
bringing the elastomer part into contact with the inner metal part;
joining the elastomer part with the inner metal part with an adhesive or by vulcanizing; and
pressing the outer sleeve onto the elastomer part during or after the joining, so that a profiling of an inner sheath surface of the outer sleeve comes into form fitting engagement with the plastic layer.

18. The method of claim 17, further comprising processing the plastic layer by one of material removing processing, cutting and is plastic deformation by the profiling during the pressing step for producing the form fitting engagement.

19. The method of claim 17, further comprising cleaning the surface of the cylindrical inner metal part and/or providing the surface of the cylindrical inner metal part with a primer during the pre-treating step.

20. The method of claim 17, further comprising prior to the pressing step, heating the elastomer part to a temperature of 50° C. to 100° C., preferably 60° C. to 80° C.

21. The method of claim 17, wherein the plastic layer is connected with the elastomer part by vulcanizing.
